(19) United States
(12) Patent Application Publication
(10) Pub. No.: US 2015/0052835 A1
(43) Pub. Date: Feb. 26, 2015

(54) DOOR ASSEMBLY WITH PIVOTABLE LOCKING EXTENSION

(71) Applicant: Pendragon S4, LLC, Toney, AL (US)

(72) Inventors: Kelly G. Falter, Toney, AL (US); Eric Philip Glover, Union Grove, AL (US)

(73) Assignee: PENDRAGON S4, LLC, Toney, AL (US)

(21) Appl. No.: 14/465,992

(22) Filed: Aug. 22, 2014

Related U.S. Application Data
(60) Provisional application No. 61/959,434, filed on Aug. 23, 2013.

(51) Int. Cl. E05C 1/10; E05C 9/10; E06B 3/36; E06B 1/52; E05D 7/00

(52) U.S. Cl. CPC E05C 1/10; E06B 1/52; E05D 7/009; E06B 3/36; E05C 9/10
USPC 52/204.1; 49/394

(57) ABSTRACT

An improved door assembly includes a door frame having a door jamb and a door having a fixed portion including a hinged side and a locking side where the hinged side of the door is hinged to the door frame. At least one of the hinged side and the locking side of the door has at least one pivotable door portion configured to pivotably move between a retracted position inside the door and an extended position that extends inside at least one complementary shaped channel within the door jamb of the door frame to interlock the door and the door frame.

### CROSS REFERENCE TO RELATED APPLICATIONS

This U.S. Application claims priority to U.S. Provisional Patent Application 61/959,434, filed Aug. 23, 2013, which is incorporated herein by reference in its entirety.

### FIELD OF THE INVENTION

The present invention relates generally to a door assembly. More particularly, the present invention relates to a door assembly including a door having at least one pivotable door portion on at least a locking side of the door that can extend into at least one complementary shaped channel of a door jamb of a door frame so as to interlock the door and door frame.

### SUMMARY OF THE INVENTION

In accordance with one embodiment of the invention, a door assembly includes a door having a fixed portion having a front side, a rear side, a hinged side, a locking side, a top, and a bottom; a door frame having a door jamb formed on a first side of the door frame and a second side of the door frame that is opposite the first side, the hinged side of the door being hinged to the first side of the door frame, the door being pivotably moveable between a closed position and at least one open position, the locking side of the door having at least one pivotable door portion configured to pivotably move between a retracted position inside the door and an extended position that extends inside at least one channel within the door jamb of the door frame to interlock said locking side of the door and the second side of the door frame, the refracted position corresponding to an unlocked door state and the extended position corresponding to a locked door state, the at least one pivotable door portion and the at least one channel having a complementary shape; and a locking control mechanism for controlling the movement of the at least one pivotable door portion between the retracted position and the extended position.

The at least one pivotably door portion and the at least one channel may be V-shaped.

The at least one pivotable door portion may be a piano hinge that pivots on a piano hinge pivot.

The locking control mechanism may include a lock handle, a plurality of vertical control rods, a plurality of axial control rods, and a plurality of pivot plates, wherein the at least one pivotable door portion rotates about a rotational axis that is perpendicular to a rotational axis of the lock handle.

The hinged side of the door may have at least one fixed door portion that extends into at least one second channel of the door jamb of the door frame to interlock the hinged side of the door and the first side of the door frame.

The at least one fixed door portion and the at least one second channel may be V-shaped.

The hinged side of the door may have at least one second pivotable door portion configured to pivotably move when the door is in the closed position between a retracted position inside the door and an extended position that extends inside at least one second channel of the door jamb the said door frame to interlock the hinged side of the door and the first side of the door frame.

The at least one second pivotable door portion and the at least one second channel may be

V-shaped.

In accordance with another embodiment of the invention, a door assembly, includes a fixed portion having a front side, a rear side, a hinged side, a locking side, a top, and a bottom, the hinged side of the door being configured to be hinged to a first side of a door frame and being configured to be locked to a second side of the door frame that is opposite the first side; and at least one pivotable door portion configured to pivotably move between a retracted position inside the door and an extended position that extends inside at least one channel within the door frame to interlock the door and the door frame, the retracted position corresponding to an unlocked door state and said extended position corresponding to a locked door state, the at least one pivotable door portion and the at least one channel having a complementary shape.

The door assembly may include the door frame.

The door assembly may include a locking control mechanism for controlling the movement of the at least one pivotable door portion between the retracted position and the extended position.

The locking control mechanism may include a lock handle, a plurality of vertical control rods, a plurality of axial control rods, and a plurality of pivot plates, wherein the at least one pivotable door portion rotates about a rotational axis that is perpendicular to a rotational axis of the lock handle.

The at least one pivotable door portion and the at least one channel may have a V-shape.

The at least one pivotable door portion may be a piano hinge that pivots on a piano hinge pivot.

The hinged side of the door may have at least one fixed door portion that extends into at least one second channel of the door frame to interlock the hinged side of the door and the first side of the door frame.

The at least one fixed door portion and the at least one second channel may be V-shaped.

The hinged side of the door may have at least one second pivotable door portion configured to pivotably move between a retracted position inside the door and an extended position that extends inside at least one second channel of the door frame to interlock the hinged side of the door and the first side of the door frame.

In accordance with yet another embodiment of the invention, a door assembly, includes a door frame having a first side and a second side opposite the first side, the first side of the door frame being configured to be hinged with a door; and

a door jamb associated with the first side and the second side of the door frame, the door jamb having at least one channel, the door having a fixed portion having a front side, a rear side, a hinged side, a locking side, a top, and a bottom, the door being pivotably moveable between a closed position and at least one open position, at least one of the locking side of the door or the hinged side of the door having at least one pivotable door portion configured to pivotably move when the door is in the closed position between a retracted position inside the door and an extended position that extends inside the at least one channel to interlock the door and the door frame, the retracted position corresponding to an unlocked door state and the extended position corresponding to a locked door state, the at least one pivotable door portion and the at least one channel having a complementary shape.

The door assembly may include the door.

The at least one pivotable door portion and the at least one channel may have a V-shape.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A depicts a rear view of an exemplary interlocking door assembly in accordance with the invention;

FIG. 1B depicts a side view of an exemplary interlocking door assembly in accordance with the invention;

FIG. 1C depicts a rear view of an exemplary door frame and door jamb in accordance with the invention;

FIG. 1D depicts a rear view of an exemplary door in accordance with the invention;

FIG. 1E depicts a side view of an exemplary cross section of the top portion of the door of FIG. 1D;

FIG. 1F depicts the exemplary interlocking door, where the locking control mechanism and piano hinge are shown in their unlocked positions.

FIG. 1G depicts the exemplary interlocking door, where the locking control mechanism and piano hinge are shown in their locked positions.

FIG. 2A depicts a top view of an exemplary interlocking door assembly in accordance with the invention where the door is in a closed position with the locking mechanism in a locked position;

FIG. 2B depicts a top view of an exemplary interlocking door assembly in accordance with the invention where the door is in an open position with the locking mechanism in an unlocked position;

FIG. 2C depicts a top view of a first side of an exemplary interlocking door assembly in accordance with the invention where the door is in an open position;

FIG. 2D depicts a top view of a second side of an exemplary interlocking door assembly in accordance with the invention where the door is in an open position;

FIG. 2E depicts a top view of an exemplary interlocking door assembly in accordance with the invention, where the door is in an closed position, the locking mechanism is in an unlocked position, and the piano hinge is in a retracted position;

FIG. 2F depicts a top view of an exemplary interlocking door assembly in accordance with the invention where the door is in an closed position, the locking mechanism is in a locked position, and the piano hinge is in an extended position;

FIG. 3A depicts a rear view of an enlargement of a portion of the access panel and locking mechanism in proximity to the lock handle, where the locking mechanism is in an unlocked position and the piano hinge is in a retracted position;

FIG. 3B depicts a rear view of an enlargement of a portion of the access panel and locking mechanism in proximity to the lock handle, where the locking mechanism is in a locked position and the piano hinge is in an extended position;

FIG. 3C depicts a rear view of an enlargement of the part of the access panel and locking mechanism in proximity to the upper axial control rod, where the locking mechanism is in an unlocked position and the piano hinge is in a retracted position;

FIG. 3D depicts a rear view of an enlargement of the part of the access panel and locking mechanism in proximity to the upper axial control rod, where the locking mechanism is in a locked position and the piano hinge is in an extended position;

FIGS. 4A and 4B depicts a top view of the swinging side of the exemplary interlocked door assembly including an exemplary locking mechanism in the unlocked and locked positions, respectivelyl;

FIG. 5A depicts a top view of the hinged side of an exemplary interlocked door assembly when the door is in the closed position in accordance with a first embodiment of the invention;

FIG. 5B depicts a top view of the hinged side of an exemplary interlocked door assembly when the door is in the closed and locked position in accordance with a second embodiment of the invention;

FIG. 5C depicts a top view of the hinged side of an exemplary interlocked door assembly when the door is in the closed position in accordance with a third embodiment of the invention; and

FIGS. 6A and 6B depict side views of enlarged portions of the exemplary interlocked door assembly and door, respectively, showing the vertical control rods, C-channel, piano hinge pivots, and square tubing.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

The present invention pertains to an interlocking door assembly for sealing and locking a door by extending a portion of the door along at least one edge of the door into a corresponding channel on at least a locking side of the door frame in order to interlock the door and frame so as to provide more strength against forced entry. The hinged side of the door may have a flange that fits into a corresponding channel on the hinged side of the door when it is closed so as the door and frame will be interlocked on both the hinged and locking sides of the door. An interlocking latch that extends partway or the full length of the door can be mounted on the locking side of the door for controlled extension into the channel in the door jamb or retraction into the door in order to lock and unlock the door. This latch may be implemented using a piano hinge. A locking control mechanism may include a lock handle mounted on the door to provide for rotational movement of a handle shaft and control plate about a locking control rotational axis. Vertical control rods connected to the control plate respond to rotational movement of the handle shaft to cause the vertical control rods to move vertically. The control rods are connected to axial control rods through 4 cantilever points, which are also referred to as pivot plates. The axial control rods are connected to the interlocking latch and cause it to extend outwardly into the channel of the door jamb or to retract inwardly into the door depending on the direction of rotation of the handle shaft. The door is suspended on a plurality of hinges to enable it to seat evenly in a casing defining the opening the door is to cover in order to establish a uniform seal force along the two adjacent vertical edges of the door and the inside edge of the casing. Unlike a conventional deadbolt mechanism which moves linearly in a direction that is perpendicular to a door frame, the interlocking latch of the present invention is pivotable relative to an interlocking latch rotational axis that is perpendicular to the locking control rotational axis (i.e., angled at 90 degrees) to facilitate a ramped engagement with the door jamb of the door frame (or casing) to increase the sealing force as it is extended into the jamb until the lock handle is in a locked position. A detent structure associated with the control plate and control rods hold the locking mechanism in a locked position until it is unlocked by rotating the lock handle to an unlocked position. Square tubing provides reinforcement to the outer edges of the inside of the door and horizontal C-channels reinforce the door. Additional or alternative reinforcement could also be provided such as vertical C-channels. An access panel is provided to allow access to the locking mechanism.

In accordance with one aspect of the invention, an interlocking door assembly includes a hinged door having a fixed portion having a front (or external) side (or face), a rear (or internal) side (or face), a hinged (or fixed) side, a locking (or swinging) side, and a top and bottom, where at least one of the locking side or the hinged side has a portion that extends into a complementary-shaped channel (or inset) of a door jamb of a door frame so as to interlock the door and the door frame when the door is closed and in a locked door state. Under one arrangement, a first door portion, for example a first V-shaped portion, on the locking side of the door and a second door portion, for example a second V-shaped portion, on the hinged side of the door extend into complementary, for example V-shaped, channels of the door jamb or door frame. When the door is being locked, for example by turning a handle clockwise, at least one of the first door portion or the second door portion pivotably extends into its corresponding channel in the doorjamb, where the door is then in a locked door state such that the door cannot be pivotably opened. When the door is being unlocked, for example by turning a handle counterclockwise, at least one of the first door portion or the second door portion pivotably retracts into the door until it no longer extends into its corresponding channel in the door jamb, where the door is then in an unlocked door state such that the door can be pivotably opened. As described below relating to an exemplary interlocking door assembly, the first and second door portions and corresponding channels of door jams may be V-shaped. However, the invention is not intended to be limited to V-shape door portions and channels. Instead, any one or more of various complementary shaped door portions and channels could be used alternatively or in combination to practice the invention. For example, round or rectangular shaped door portions and channels could be used. Moreover, it is not necessary that the shape of the channel and shape of the door portion be entirely complementary. Generally, at least part of the shape of the channel can be complementary to a corresponding part of the door portion to interlock the door and the door frame.

In a first embodiment of the invention, a first door portion on the hinged side of a door is also a fixed portion of the door, for example an angled flange, that always extends from the hinged side of the door such that it will extend into a corresponding channel in a door jamb when the door is closed. A second door portion on the locking side of the door is pivotable door portion configured to pivotably move between a first position where it is extended into a corresponding channel of a door jamb so as to interlock the door and a door frame and a second position where it is retracted inside the door such that the door can be opened. A locking mechanism is used to pivotably move the second door portion between its first (extended) position and second (retracted) position.

In a second embodiment of the invention, at least one first door portion on the hinged side of a door and at least one second door portion on the locking side of the door are pivotable door portions configured to pivotably move between first positions where they are extended into corresponding channels in door jambs so as to interlock the door and a door frame and second positions where they are retracted inside the door such that the door can be opened. With this embodiment, at least one locking mechanism is used to pivotably move the first and second door portions between their first (extended) positions and their second (retracted) positions, where the first and second door portions can pivotably move together or pivotably move independently.

In a third embodiment of the invention, a first door portion on the locking side of a door is a pivotable door portion configured to pivotably move between a first position where it is extended into a corresponding channel of a door jamb so as to interlock the door and a door frame and a second position where it is retracted inside the door such that the door can be opened. A locking mechanism is used to pivotably move the first door portion between its first (extended) position and second (retracted) position.

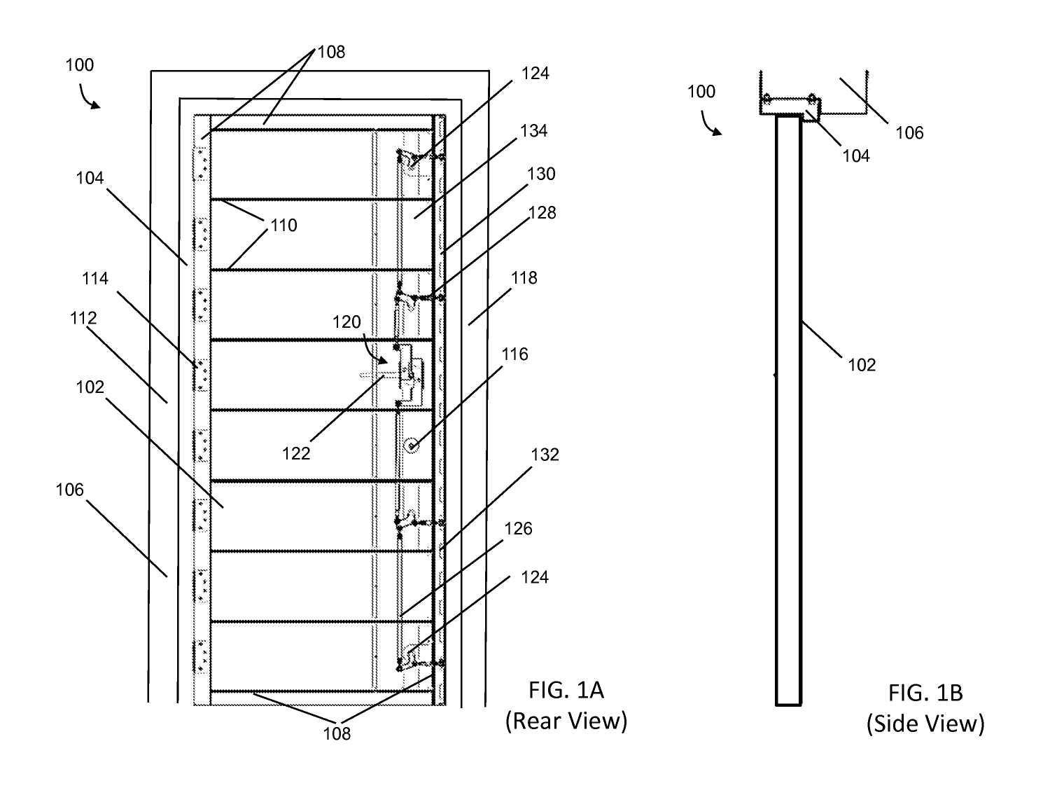

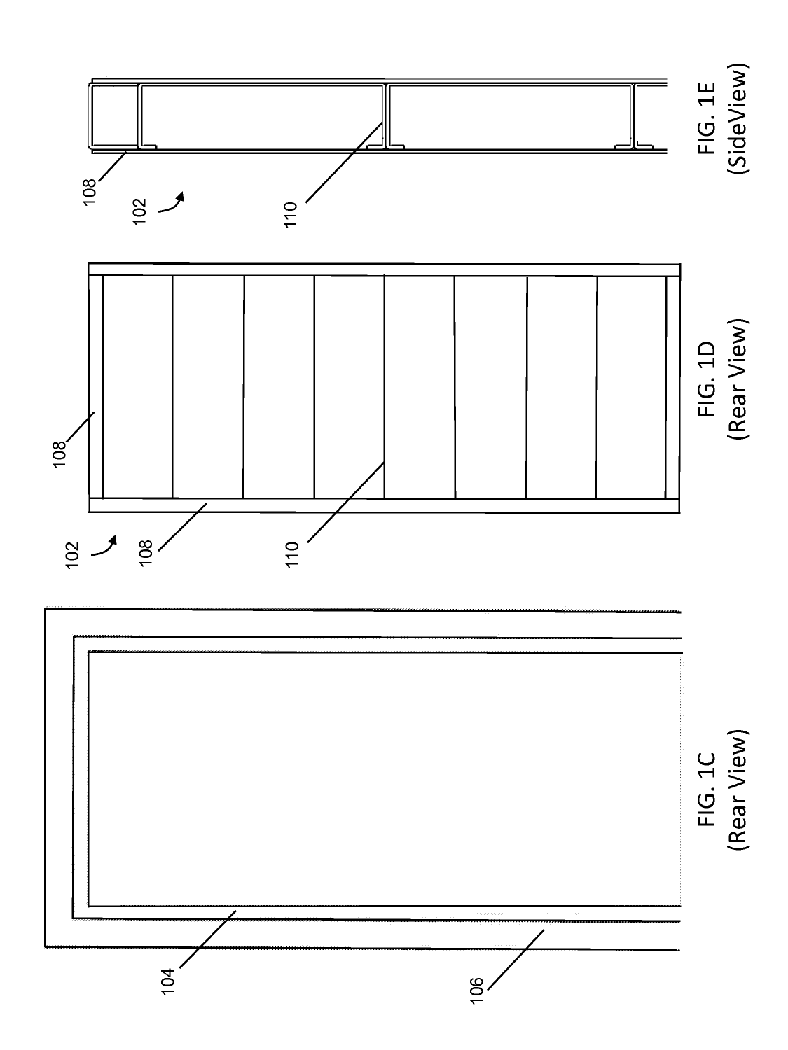

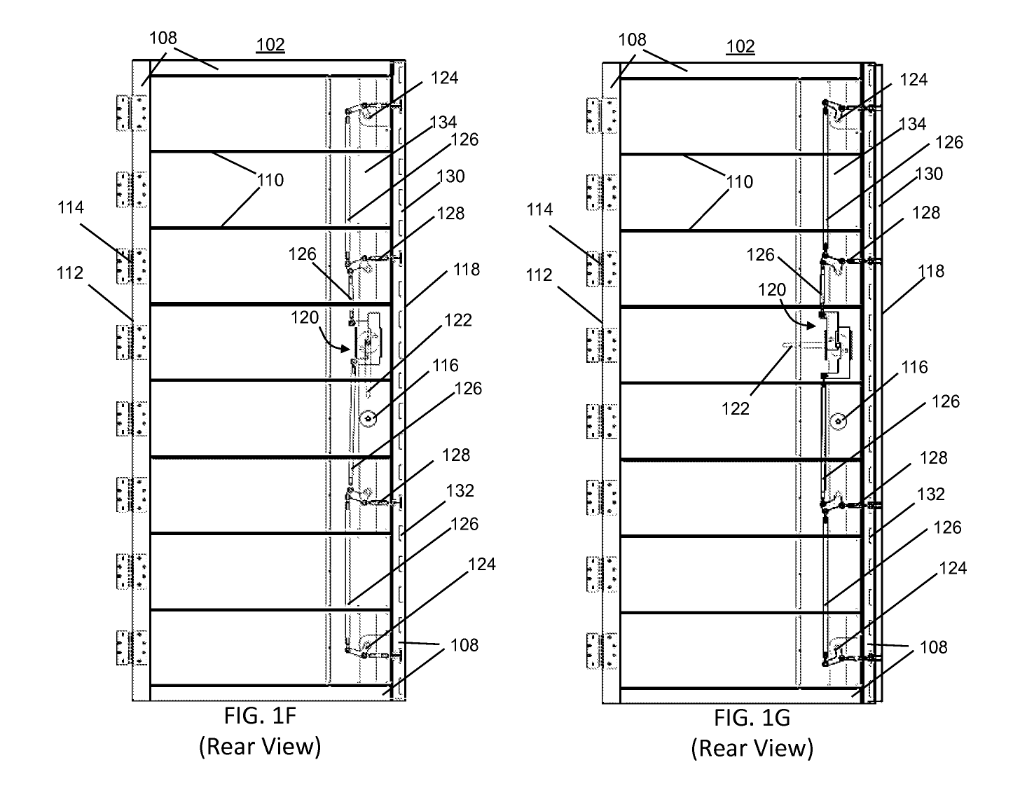

FIG. 1A depicts a rear view of an exemplary interlocking door assembly 100 in accordance with the first embodiment of the invention. Referring to FIG. 1A, interlocking door assembly 100 includes a door 102 that interlocks with door jambs 104 of a door frame 106. Door 102 is constructed using a configuration of square tubing 108 and C-Channels 110 but could be otherwise constructed. The square tubing functions as top, bottom, and side rails and the C-channels serve as cross rails. The door 102 is pivotably attached to a first door jamb 104 on a first side 112 of the door frame 106 using standard door hinges 114. As such, the door can be opened and closed using a standard door knob 116 located on the locking side of the door 102 near the second side 118 of the door frame 106. As shown in the rear view, the first side 112 corresponds to the hinged side and the second side 118 corresponds to the locking side. Alternatively, the first side 112 could correspond to the locking side and second side 118 could correspond to the hinged side such that the door would have an opposite inside swing. Moreover, the door jambs 104 and door frame 106 do not have to be separate but instead could be integrated.

FIG. 1A depicts a locking control mechanism 120 including a lock handle 122, pivot plates (or cantilever points) 124, vertical control rods 126, and axial control rods 128. The locking control mechanism 120 is configured to pivotably move a piano hinge 130 relative to a piano hinge pivot 132 such that the second door portion of the door 102 pivotably moves between a first (extended) position when the lock handle 122 is in a first (locked) position and a second (retracted) position when the lock handle 122 is in a second (unlocked) position. FIG. 1A depicts the locking control mechanism 120 i. FIG. 1A also depicts one or more access panels 134 that can be removed by removing screws or other attachment mechanism (e.g., magnets, Velcro, etc.) in order to provide access to the various components of the locking control mechanism 120.

FIG. 1B depicts a side view of the exemplary interlocking door assembly 100 of FIG. 1A. Referring to FIG. 1B, the interlocking door assembly 100 includes a door 102 and a door frame 106 and an associated door jamb 104.

FIG. 1C depicts a rear view of an exemplary door frame 106 and door jamb 104 in accordance with the invention.

FIG. 1D depicts a rear view of an exemplary door 102 in accordance with the invention. Referring to FIG. 1D, the door 102 is configured using square tubing 108 and C-channels 110.

FIG. 1E depicts a side view of an exemplary cross section of the top portion of the door 102 of FIG. 1D. Referring to FIG. 1E, the door 102 is configured using square tubing 108 and C-channels 110.

FIGS. 1F and 1G depict the exemplary interlocking door 102 with the locking control mechanism 120 and piano hinge 130 shown in their unlocked and locked positions, respectively.

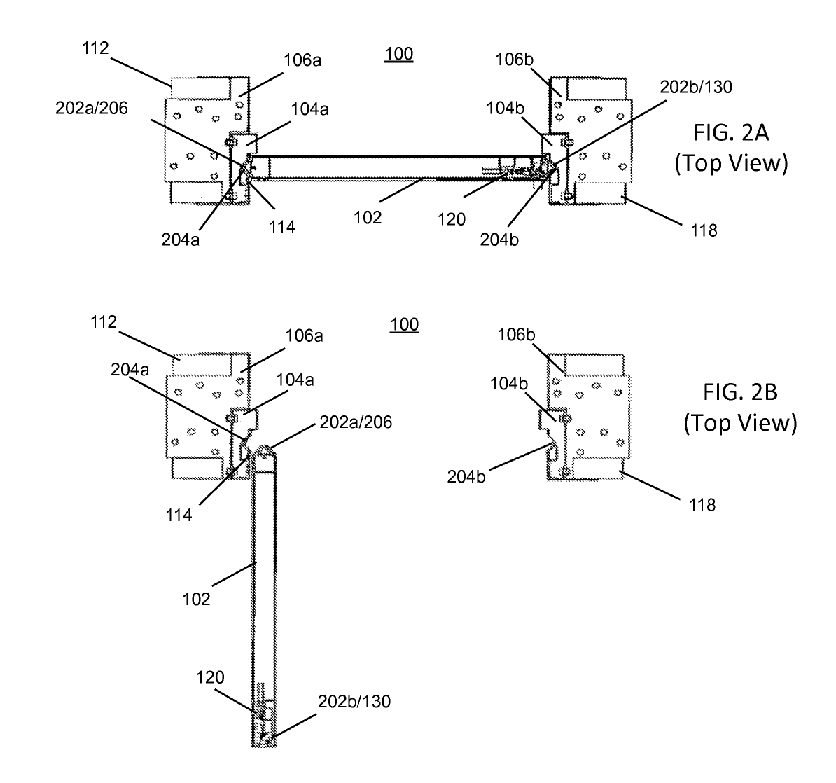

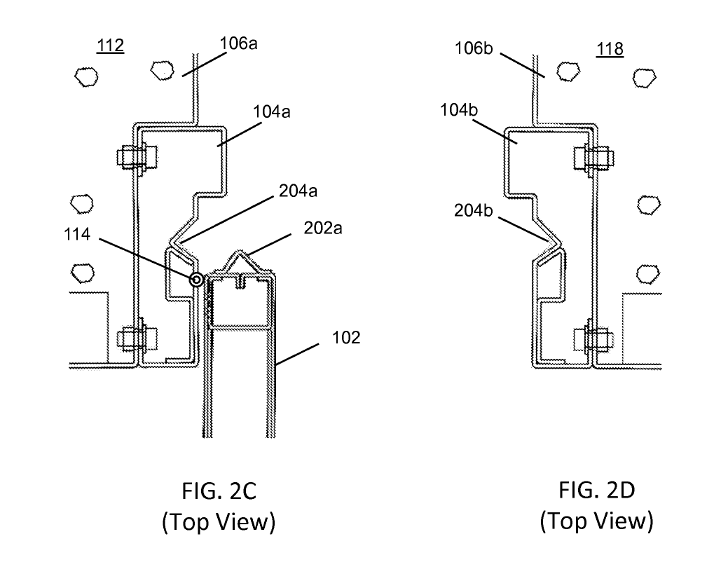

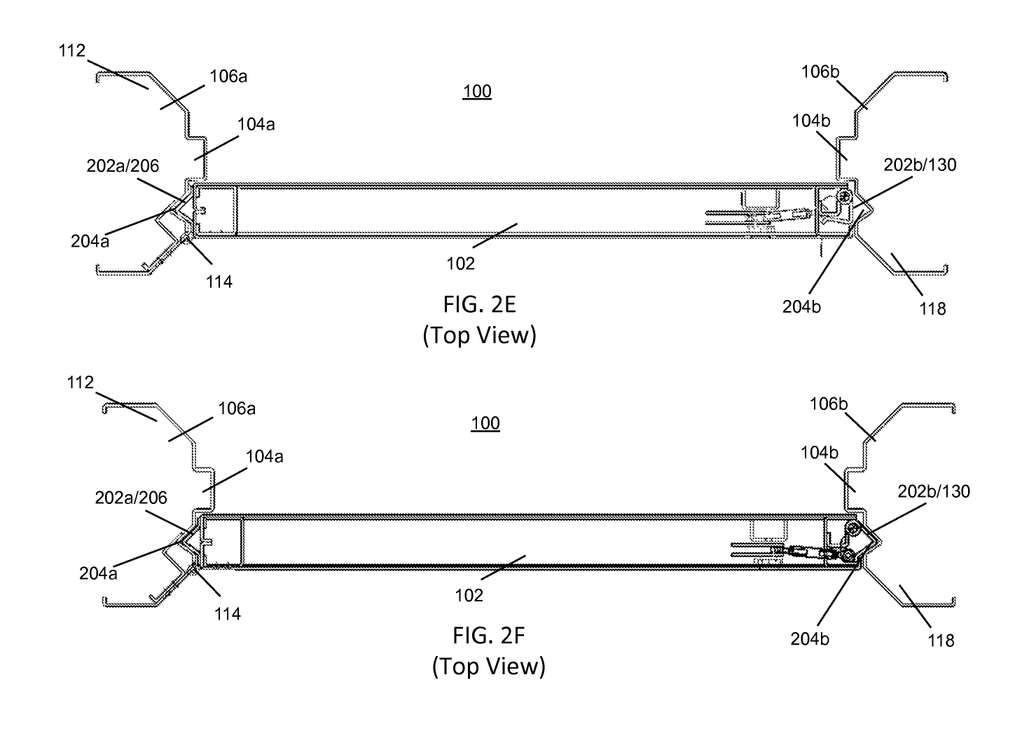

FIG. 2A depicts a top view of an exemplary interlocking door assembly 100 in accordance with the invention where the door 102 is in a closed position with the locking control mechanism 120 in a locked position. Referring to FIG. 2A, interlocking door assembly 100 includes a first side 112 and a second side 118 and a door 102 interlocked between the first side 112 and the second side 118. Specifically, the door 102 has a first V-shaped door portion 202a and a second V-shaped door portion 202b. As shown, the first V-shaped door portion is a fixed door portion, for example an angled flange 206, and the second V-shaped door portion 202b, for example a piano hinge 130, is a pivotable door portion, which is pivotably moveable relative to a piano hinge pivot 132 such that it can extend or retract. The first and second door portions are shown extending into corresponding complementary V-shaped channels 204a 204b.

FIG. 2B depicts a top view of an exemplary interlocking door assembly 100 in accordance with the invention where the door 102 is in an open position with the locking control mechanism 120 in an unlocked position. Referring to FIG. 2B, interlocking door assembly 100 includes a first side 112 and a second side 118 and a door 102 in an open position where its first door portion 202a is outside its corresponding channel 204a. On the locking side of the door 102, the second door portion 202b is a pivotable door portion shown in its retracted position inside the door 102. As such, the channel 204b that corresponds to the second door portion is shown on the second side 118 of the door assembly 100.

FIG. 2C depicts a top view of a first side 112 of an exemplary interlocking door assembly 100 in accordance with the invention where the door 102 is in an open position. Referring to FIG. 2C, the first door portion 202a of the door 102 is a fixed door portion shown being outside of its corresponding channel 204a.

FIG. 2D depicts a top view of a second side 118 of an exemplary interlocking door assembly 100 in accordance with the invention where the door 102 is in an open position such that channel 204b is shown.

FIG. 2E depicts a top view of an exemplary interlocking door assembly 100 in accordance with the invention where the door 102 is in a closed position and the locking mechanism 120 is in an unlocked position and the piano hinge 130 is in a refracted position, where the door jab 104 and door frame 106 are integrated.

FIG. 2F depicts a top view of an exemplary interlocking door assembly 100 in accordance with the invention where the door 102 is in an closed position and the locking mechanism 120 is in a locked position and the piano hinge 130 is in an extended position, where the door jab 104 and door frame 106 are integrated.

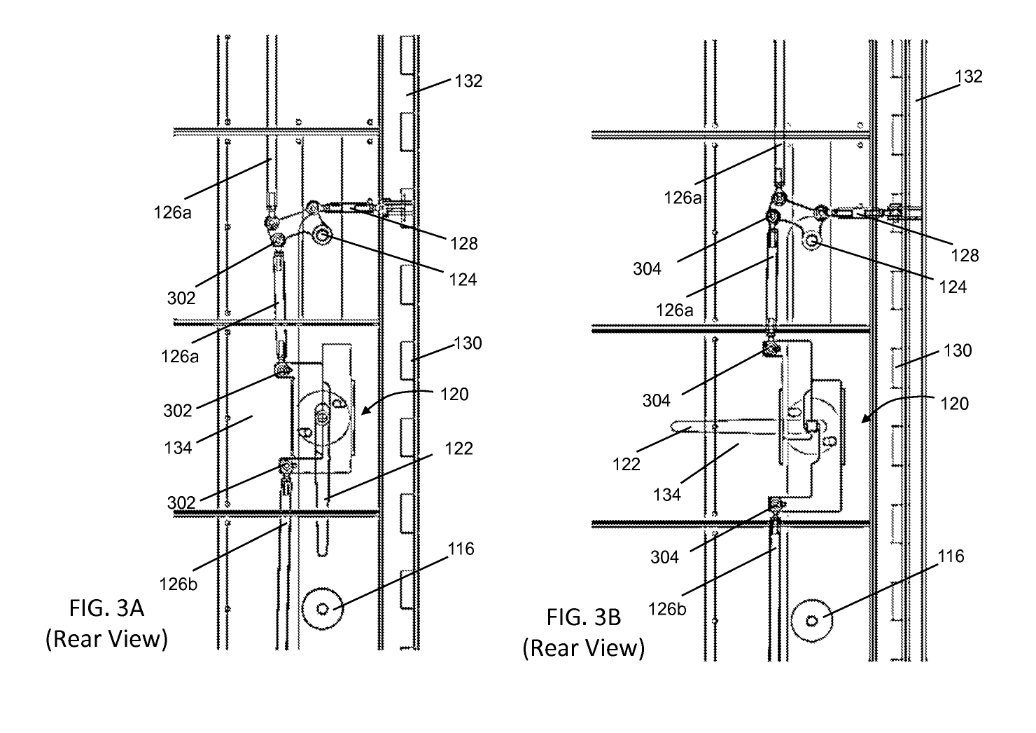

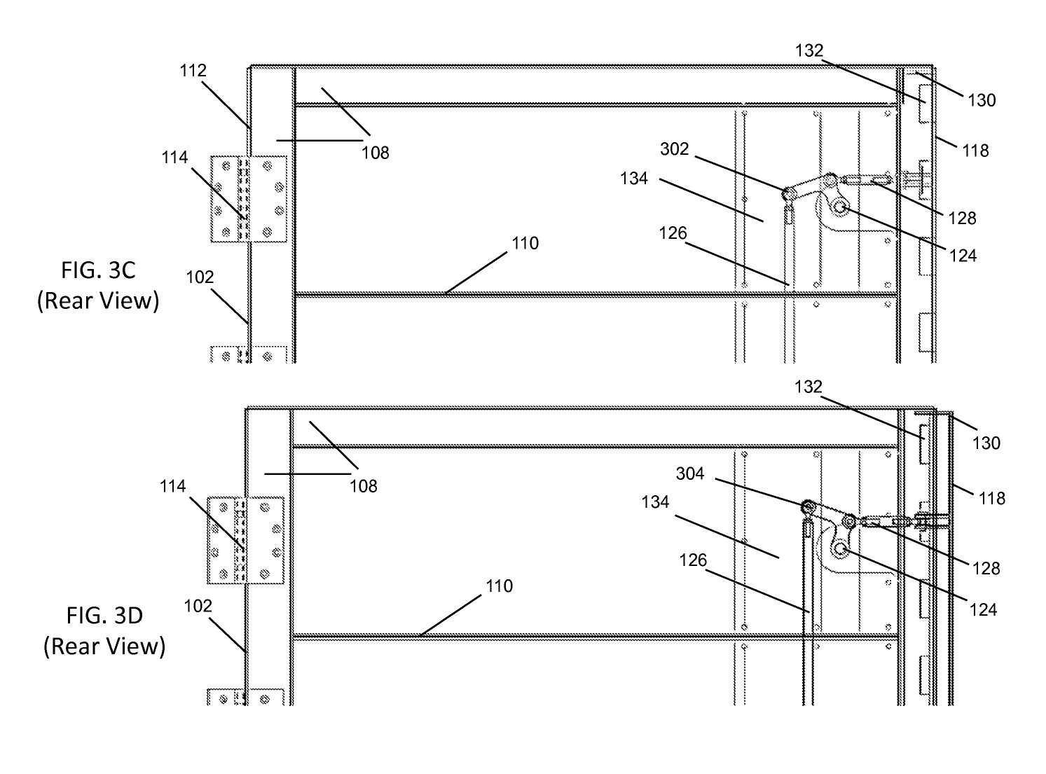

FIG. 3A depicts a rear view of an enlargement of the part of the access panel 34 and locking mechanism 120 in proximity to the lock handle 122, where the locking mechanism 120 is in an unlocked position 302 and the piano hinge 130 is in a retracted position. Referring to FIG. 3A, depicted are doorknob 116 and piano hinge 130 and a locking control mechanism 120 comprising a pivot plate 124 and a first set of vertical control rods 126a extending upward from the lock handle 122 and a second set of vertical control rods 126b extending downward from the lock handle 122. The vertical control rods 126a 126b are shown having first positions 302, which corresponds to when the lock handle 122 is in an unlocked position. Also shown is an axial control rod 128 in its unlocked position. The vertical control rods 126a 126b move up and down while the axial control rod 128 moves from left to right when the lock handle 122 is moved from an unlocked to a locked position, and vice versa, so as to control the pivotable movement of the piano hinge 130. When the lock handle 122 is in its unlocked position, the piano hinge 130, which corresponds to the second door portion 202b of the door 102, is in its retracted position inside the door as shown in FIG. 3A.

FIG. 3B depicts a rear view of an enlargement of the part of the access panel 34 and locking mechanism 120 in proximity to the lock handle 122, where the locking mechanism 120 is in a locked position 304 and the piano hinge 130 is in an extended position.

FIG. 3C depicts a rear view of an enlargement of the part of the access panel 34 and locking mechanism 120 in proximity to the upper axial control rod 128, where the locking mechanism 120 is in an unlocked position 302 and the piano hinge 130 is in a retracted position.

FIG. 3D depicts a rear view of an enlargement of the part of the access panel 34 and locking mechanism 120 in proximity to the upper axial control rod 128, where the locking mechanism 120 is in a locked position 304 and the piano hinge 130 is in an extended position.

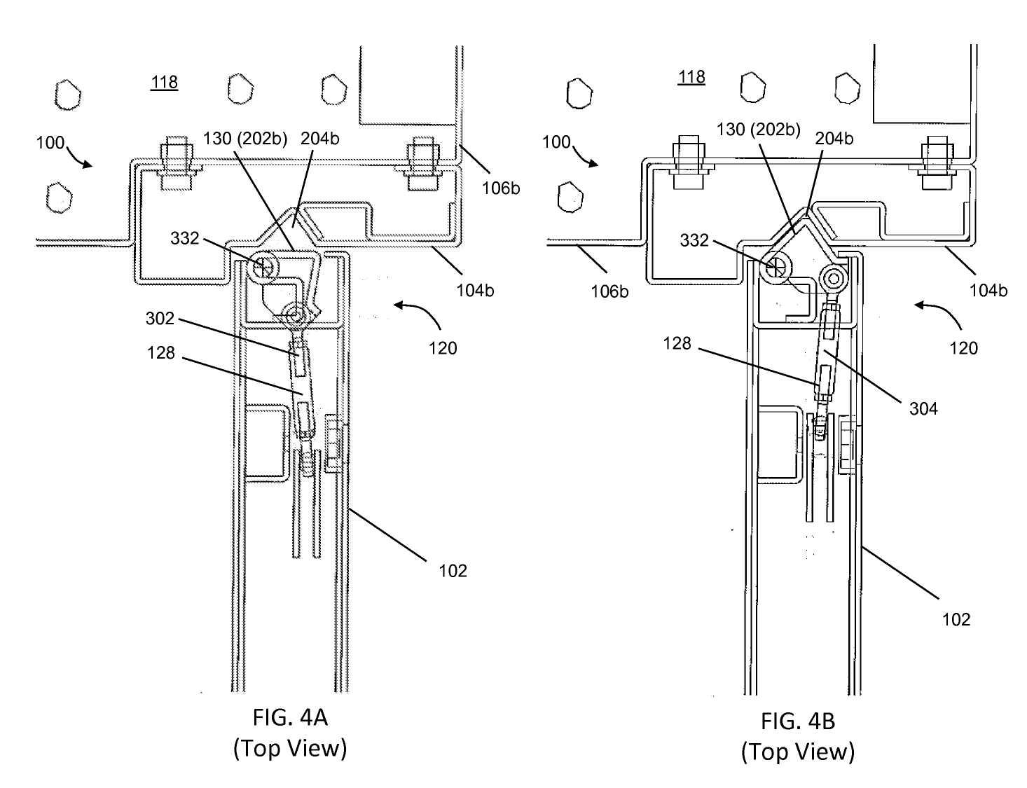

FIGS. 4A and 4B depict a top view of the locking side of the exemplary interlocked door assembly 100 including an exemplary locking control mechanism 120 in the unlocked and locked positions, respectively. Referring to FIGS. 4A and 4B, a door 102 is shown in a closed position relative to the second side 118 of a door frame 106b having a door jamb 104b. Components of an exemplary locking control mechanism 120 including axial control rod 128 and piano hinge 130 are shown in FIG. 4A in an unlocked position 302 and in FIG. 4B in a locked position 304. When in its unlocked position 302, the piano hinge 130, which may also be referred to as the second door portion 202b, is retracted into the door 102 such that it is outside its corresponding channel 204b of door jamb 104b of door frame 106b. When in its locked position 304, the piano hinge 130 extends such that it is inside its corresponding channel 204b of the door jamb 104b of the door frame 106b.

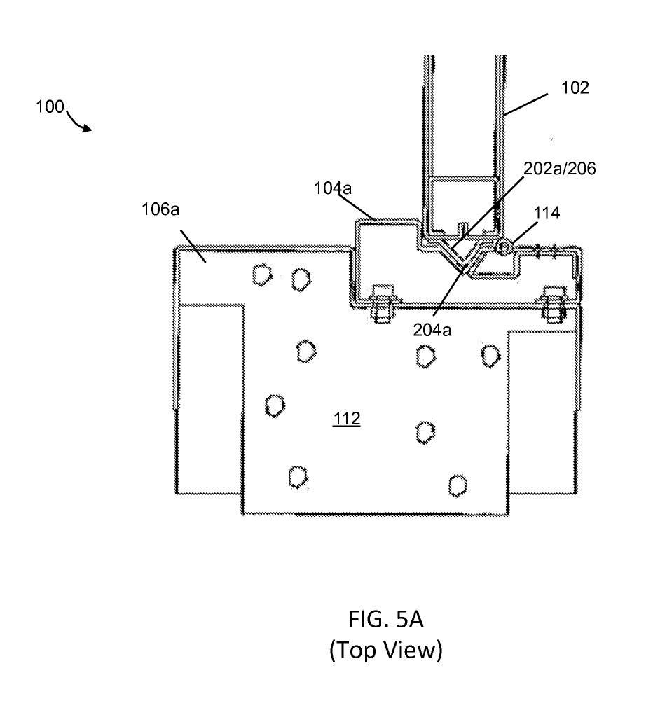

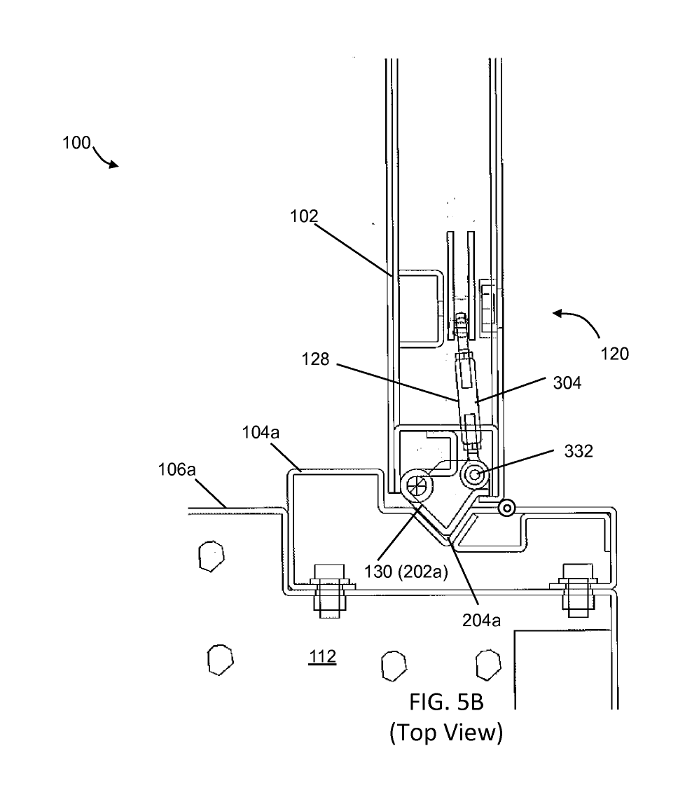

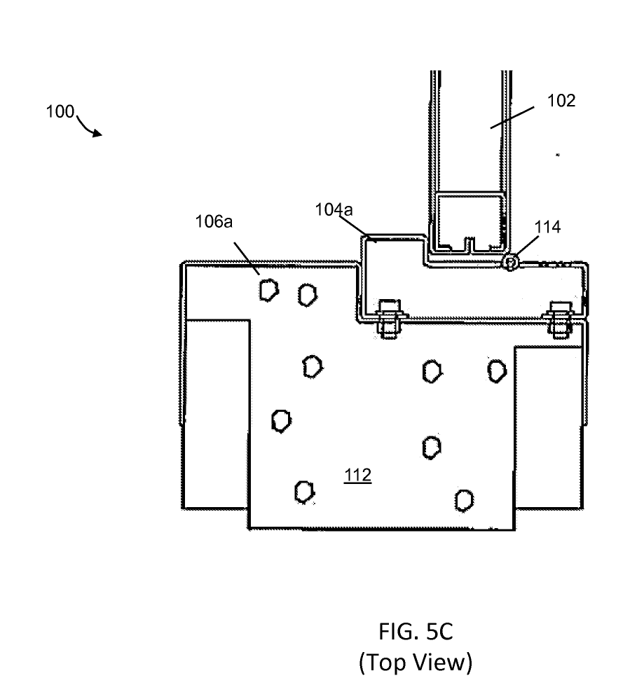

FIG. 5A depicts a top view of the hinged side of an exemplary interlocked door assembly 100 when the door is in the closed position in accordance with the first embodiment of the invention. Referring to FIG. 5A, a hinged side of a door 102 is shown in a closed position relative to the first side 112 of a door frame 106a having a door jamb 104a. The door 102 is pivotably attached to the door jamb 104a using a plurality of hinges 114. When in the closed position, a first door portion 202a, which is a fixed door portion such as an angled flange 206, is extended into a corresponding channel 204a in the door jamb 104a.

FIG. 5B depicts a top view of the hinged side of an exemplary interlocked door assembly 100 when the door is in the closed and locked position in accordance with the second embodiment of the invention. Referring to FIG. 5B, a hinged side of a door 102 is shown in a closed position relative to the first side 112 of a door frame 106a having a door jamb 104a. The door 102 is pivotably attached to the door jamb 104a using a plurality of hinges 114. Components of an exemplary locking control mechanism 120 including axial control rod 128 and piano hinge 130 are shown in a locked position 304, where the piano hinge 130 extends such that it is inside its corresponding channel 204a of door jamb 104a of door frame 106a.

FIG. 5C depicts a top view of the hinged side of an exemplary interlocked door assembly 100 when the door is in the closed position in accordance with the third embodiment of the invention. Referring to FIG. 5B, a hinged side of a door 102 is shown in a closed position relative to the first side 112 of a door frame 106a having a door jamb 104a. The door 102 is pivotably attached to the door jamb 104a using a plurality of hinges 114.

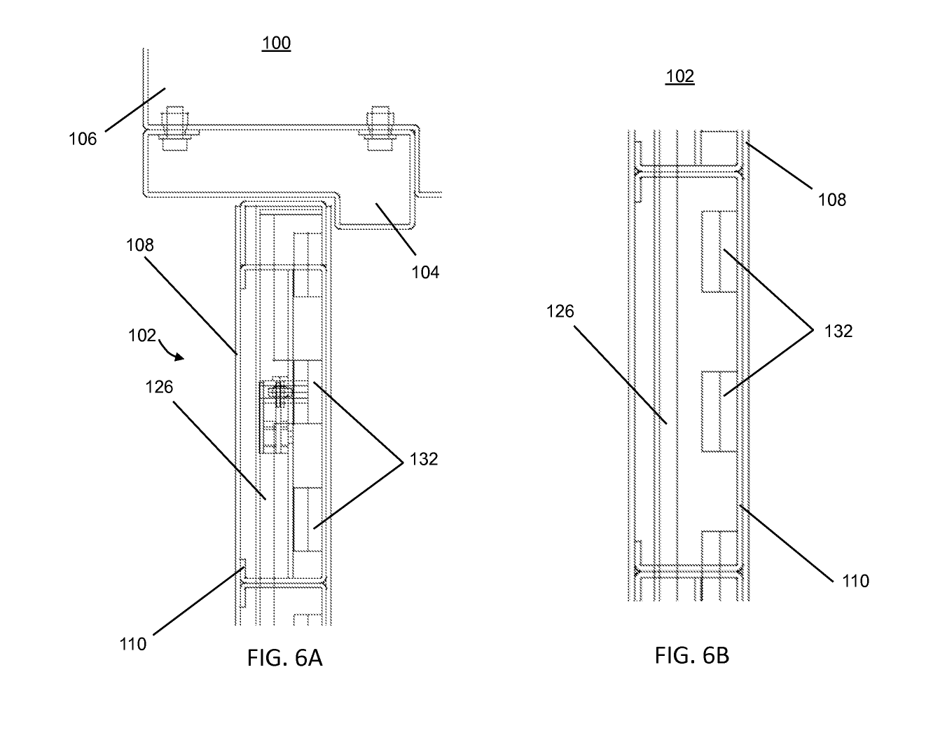

FIGS. 6A and 6B depict side views of enlarged portions of the exemplary interlocked door assembly 100 and door 102, respectively, showing the vertical control rods 126, C-channel 110, piano hinge pivots 132, and square tubing 108.

It should be noted that the first and second door portions and corresponding channels have been described where they extend the full height of the door and corresponding frame so as provide the strongest seal and therefore the greatest ability to withstand a force. However, one skilled in the art will recognize that the invention can be practiced where the lengths of the first and/or second door portions are such that they do not extend the full height of the door and corresponding frame, where the corresponding channels in the door jambs may extend the full height of the door or may correspond to the length of the first and/or second door portions should they be less than the height of the door. Moreover, various configurations are possible where there are a plurality of first door portions and/or a plurality of second door portions where the corresponding channels may extend the full height of the door or may correspond to the various lengths and locations of the plurality of first door portions and/or the plurality of second door portions.

It should also be noted that the mechanical systems used to control the movement of a pivotable portion can be implemented in many different ways. For example, the pivotable portion might be moveable by controlling solenoids that move the pivotable portion between the refracted and extended positions.

Generally, the interlocking door assembly of the present invention can be used in a secure facility, a safe room, a bomb shelter, a storm shelter, etc., which may be located at a business or in a home. The door could also include any one of a doorstop, a window, a decorative ornament, an alarm sensor, a seal (e.g., a waterproof seal), a key lock, and any other door-related component well known in the art. Moreover, the combination of the pivotable portion that can move from a position retracted inside a hinged object to an extended position that extends the portion into a complementary channel of a second object where the first object can pivotably move to close an opening in the second object and a control mechanism for moving the pivotable portion between the retracted and extended position so as to change the state of the hinged object from a moveable state to a non-moveable state can be used to close and secure other openings such as windows, portals, and the like. For example, the invention could be used in a storm shutter system such as a hurricane shutter system, where the channel could be integrated into a window frame, etc.

While particular embodiments of the invention have been described, it will be understood, however, that the invention is not limited thereto, since modifications may be made by those skilled in the art, particularly in light of the foregoing teachings.

1. A door assembly, comprising:
a door having a fixed portion having a front side, a rear side, a hinged side, a locking side, a top, and a bottom;
a door frame having a door jamb formed on a first side of said door frame and a second side of said door frame that is opposite said first side, said hinged side of said door being hinged to said first side of said door frame, said door being pivotably moveable between a closed position and at least one open position, said locking side of said door having at least one pivotable door portion configured to pivotably move between a retracted position inside said door and an extended position that extends inside at least one channel within said door jamb of said door frame to interlock said locking side of said door and said second side of said door frame, said retracted position corresponding to an unlocked door state and said extended position corresponding to a locked door state, said at least one pivotable door portion and said at least one channel having a complementary shape; and
a locking control mechanism for controlling the movement of said at least one pivotable door portion between said retracted position and said extended position.

2. The door assembly of claim 1, where said at least one pivotably door portion and said at least one channel are V-shaped.

3. The door assembly of claim 1, where at least one pivotable door portion is a piano hinge that pivots on a piano hinge pivot.

4. The door assembly of claim 1, where said locking control mechanism comprises a lock handle, a plurality of vertical control rods, a plurality of axial control rods, and a plurality of pivot plates, wherein said at least one pivotable door portion rotates about a rotational axis that is perpendicular to a rotational axis of said lock handle.

5. The door assembly of claim 1, wherein said hinged side of said door has at least one fixed door portion that extends into at least one second channel of said door jamb of said door frame to interlock said hinged side of said door and said first side of said door frame.

6. The door assembly of claim 5, wherein said at least one fixed door portion and said at least one second channel are V-shaped.

7. The door assembly of claim 1, wherein said hinged side of said door has at least one second pivotable door portion configured to pivotably move when said door is in said closed position between a retracted position inside said door and an extended position that extends inside at least one second channel of said door jamb of said door frame to interlock said hinged side of said door and said first side of said door frame.

8. The door assembly of claim 7, wherein said at least one second pivotable door portion and said at least one second channel are V-shaped.

9. A door assembly, comprising:
a fixed portion having a front side, a rear side, a hinged side, a locking side, a top, and a bottom, said hinged side of said door being configured to be hinged to a first side of a door frame and being configured to be locked to a second side of said door frame that is opposite said first side; and
at least one pivotable door portion configured to pivotably move between a retracted position inside said door and an extended position that extends inside at least one channel within said door frame to interlock said door and said door frame, said retracted position corresponding to an unlocked door state and said extended position corresponding to a locked door state, said at least one pivotable door portion and said at least one channel having a complementary shape.

10. The door assembly of claim 9, further comprising:
said door frame.

11. The door assembly of claim 9, further comprising:
a locking control mechanism for controlling the movement of said at least one pivotable door portion between said retracted position and said extended position.

12. The door assembly of claim 11, wherein said locking control mechanism comprises a lock handle, a plurality of vertical control rods, a plurality of axial control rods, and a plurality of pivot plates, wherein said at least one pivotable door portion rotates about a rotational axis that is perpendicular to a rotational axis of said lock handle.

13. The door assembly of claim 9, wherein said at least one pivotable door portion and said at least one channel have a V-shape.

14. The door assembly of claim 9, where at least one pivotable door portion is a piano hinge that pivots on a piano hinge pivot.

15. The door assembly of claim 9, wherein said hinged side of said door has at least one fixed door portion that extends into at least one second channel of said door frame to interlock said hinged side of said door and said first side of said door frame.

16. The door assembly of claim 9, wherein said at least one fixed door portion and said at least one second channel are V-shaped.

17. The door assembly of claim 9, wherein said hinged side of said door has at least one second pivotable door portion configured to pivotably move between a retracted position inside said door and an extended position that extends inside at least one second channel of said door frame to interlock said hinged side of said door and said first side of said door frame.

18. A door assembly, comprising:
a door frame having a first side and a second side opposite said first side, said first side of said door frame being configured to be hinged with a door; and
a door jamb associated with said first side and said second side of said door frame, said door jamb having at least one channel, said door having a fixed portion having a front side, a rear side, a hinged side, a locking side, a top, and a bottom, said door being pivotably moveable between a closed position and at least one open position, at least one of said locking side of said door or said hinged side of said door having at least one pivotable door portion configured to pivotably move when said door is in said closed position between a retracted position inside said door and an extended position that extends inside said at least one channel to interlock said door and said door frame, said retracted position corresponding to an unlocked door state and said extended position corresponding to a locked door state, said at least one pivotable door portion and said at least one channel having a complementary shape.

19. The door assembly of claim 18, further comprising:
said door.

20. The door assembly of claim 18, wherein said at least one pivotable door portion and said at least one channel have a V-shape.
